(19) United States
(12) Patent Application Publication
(10) Pub. No.: US 2007/0222331 A1
(43) Pub. Date: Sep. 27, 2007

(54) Small heat-dissipating device

(75) Inventors: Alex Horng, Kaohsiung (TW); Tso-Kuo Yin, Kaohsiung (TW)

Correspondence Address: BIRCH STEWART KOLASCH & BIRCH, PO BOX 747, FALLS CHURCH, VA, 22040-0747, US

(73) Assignee: Sunonwealth Electric Machine Industry Co., Ltd.

(21) Appl. No.: 11/432,374

(22) Filed: May 12, 2006

(30) Foreign Application Priority Data
Mar. 27, 2006 (TW) 95110490

(51) Int. Cl. H02K 1/22

(52) U.S. Cl. 310/268; 417/353

(57) ABSTRACT

A small heat-dissipating device includes a casing and an impeller rotor. The casing includes a compartment delimited by a base. An axial tube extends from the base. At least two positioning members are mounted on the base and outside the axial tube. The positioning members are made of magnetically conductive materials. The positioning members provide a downward magnetic attraction to a magnet on the impeller rotor for preventing disengagement of the impeller rotor during rotation. Further, when the impeller rotor is at rest, the positioning members attract the magnet of the impeller rotor to retain the impeller rotor in an angular position most suitable for starting and to prevent the impeller rotor from resting at a dead point for starting, thereby reducing the power required for starting.

### BACKGROUND OF THE INVENTION

1. Field of the Invention

The present invention relates to a small heat-dissipating device. More particularly, the present invention relates to a small heat-dissipating device that utilizes magnetic attraction to retain a rotor of an impeller at rest in an angular position most suitable for starting, thereby reducing the power required for starting.

2. Description of Related Art

Although the trend of integrated circuit layouts is precision and complication, the consumers prefer products that are light, thin, and small, which is particularly true for 3C electronic products. Miniaturization of the heat-dissipating devices in the electronic products is thus inevitable.

Taiwan Patent Application No. 84209577 discloses a combined structure for a small heat-dissipating fan—motor wherein a casing, a stator device, and a rotor are combined to form a miniaturized heat-dissipating unit. The casing includes a base therein. A tube is provided on a center of the base and receives an axial tube having a central hole for supporting rotation of an impeller of the rotor. The stator device includes a circuit board fixed on the base, a plurality of silicon-steel plates, and a coil. The endless coil and the silicon-steel plates are fixed to the circuit board by gluing. A magnet is fixed to a bottom surface of the impeller. A shaft extends from a center of the impeller and through the central hole of the axial tube. Power is supplied to an IC control units on the circuit board for creating a magnetic field for driving the rotor to turn through induction with the magnet of the impeller.

Although the overall thickness of the heat-dissipating fan is largely reduced, there is a limitation to the overall thickness of the coil and the silicon-steel plates that are fixed to the circuit board by gluing. More specifically, the overall thickness of the coil and the silicon-steel plates limits further miniaturization of the heat-dissipating fan while considering the needs of small electronic products.

### SUMMARY OF THE INVENTION

A small heat-dissipating device in accordance with the present invention comprises a casing and an impeller rotor. The impeller rotor comprises a plurality of vanes on an outer circumference thereof. A magnet is fixed to a bottom surface of the impeller rotor. A shaft is fixed to a center of the impeller rotor. The casing includes a compartment-delimited by a base. A circuit board is mounted on the base. At least one coil is mounted on the circuit board and in association with the magnet. An axial tube extends from a center of the base. A bearing is mounted in the axial tube for rotatably supporting the shaft of the impeller rotor. At least two positioning members are mounted on the base and outside the axial tube. The positioning members are made of magnetically conductive materials.

The positioning members provide a downward magnetic attraction to the magnet on the impeller rotor for preventing disengagement of the impeller rotor during rotation. Further, when the impeller rotor is at rest, the positioning members attract the magnet of the impeller rotor to retain the impeller rotor in an angular position most suitable for starting and to prevent the impeller rotor from resting at a dead point for starting, thereby reducing the power required for starting.

In a case that two positioning members are used, the two positioning members are diametrically opposed to each other.

In another case that three positioning members are used, the three positioning members are spaced by regular angular intervals on the base.

Preferably, an air outlet is defined in a side of the compartment. A lid is mounted on top of the casing and includes an air inlet facing the impeller rotor.

Other objects, advantages and novel features of this invention will become more apparent from the following detailed description when taken in conjunction with the accompanying drawings.

### BRIEF DESCRIPTION OF THE DRAWINGS

FIG. 1 is an exploded perspective view of a first embodiment of a small heat-dissipating device in accordance with the present invention;

FIG. 2 is a sectional view of the first embodiment of the small heat-dissipating device in accordance with the present invention;

FIG. 3 is a plan view of the first embodiment of the small heat-dissipating device in accordance with the present invention; and

FIG. 4 is a plan view of a second embodiment of the small heat-dissipating device in accordance with the present invention.

### DETAILED DESCRIPTION OF THE PREFERRED EMBODIMENTS

The present invention relates to a small heat-dissipating device comprises a base on which an axial tube is mounted. At least two positioning members are mounted on the base and outside the axial tube and made of magnetically conductive materials. The positioning members provide a downward magnetic attraction to the magnet on an impeller rotor for preventing disengagement of the impeller rotor during rotation. Further, when the impeller rotor is at rest, the positioning members attract the magnet of the impeller rotor to retain the impeller rotor in an angular position most suitable for starting and to prevent the impeller rotor from resting at a dead point for starting, thereby reducing the power required for starting.

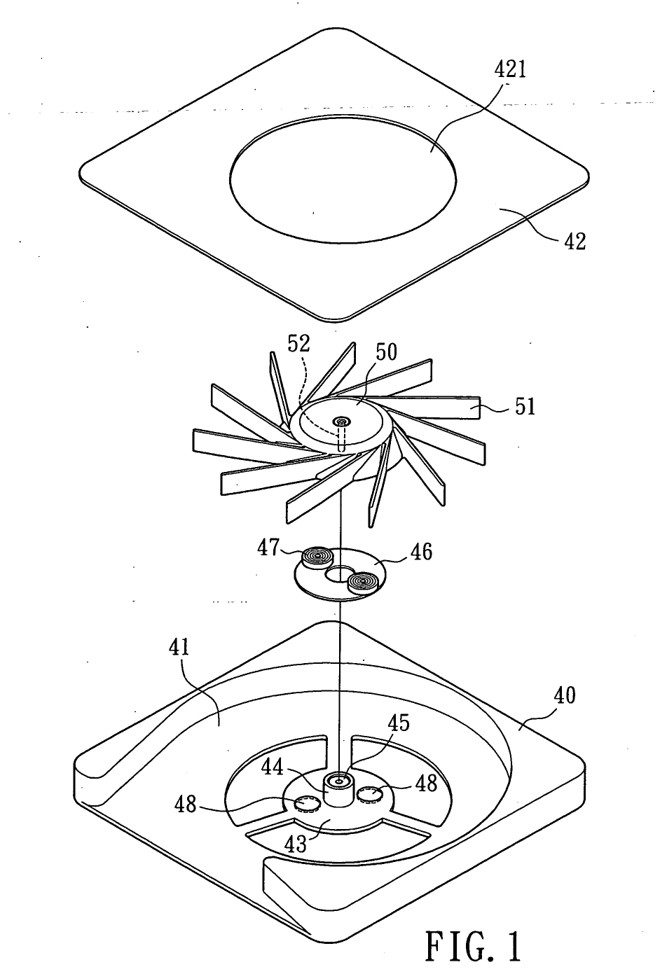

FIG. 1 is an exploded perspective view of a first embodiment of a small heat-dissipating device in accordance with the present invention. The small heat-dissipating device includes a casing 40 defining a space 41 for receiving an impeller rotor 50. A lid 42 is mounted on top of the casing 40 and includes an air inlet 421 facing the impeller rotor 50. When the impeller rotor 50 turns, a plurality of vanes 51 on an outer circumference of the impeller rotor 50 suck air into the compartment 41 of the casing 40 via the air inlet 421 and output air via the other side of the compartment 41 for the purposes of dissipating heat-generating electronic components.

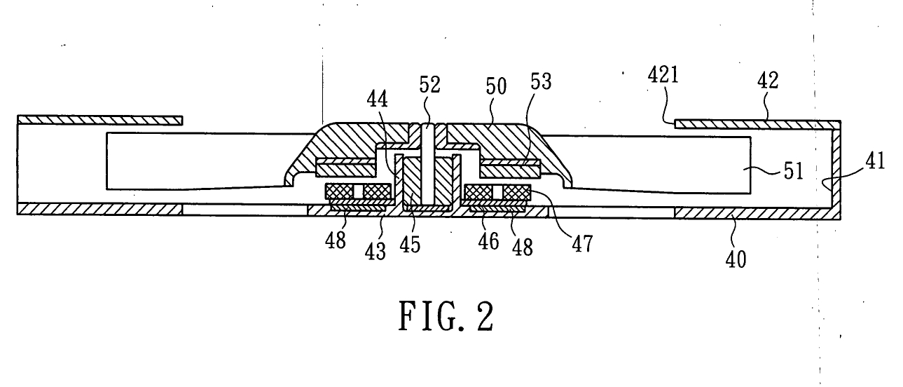

Referring to FIG. 2, the impeller rotor 50 is mounted to a base 43 delimiting a bottom of the compartment 41. A circuit board 46 and coils 47 are mounted to the base 43. An axial tube 44 extends from a center of the base 43 and receives a bearing 45 having a central hole through which a shaft 52 of the impeller rotor 50 extends. Namely, the shaft 52 of the impeller rotor 50 is rotatably supported in the bearing 45. An IC control unit (not shown) is provided on the circuit board 46. Power is supplied to the circuit board 46 to drive the impeller rotor 50 to turn through induction by a magnet 53 fixed to a bottom surface of the impeller rotor 50.

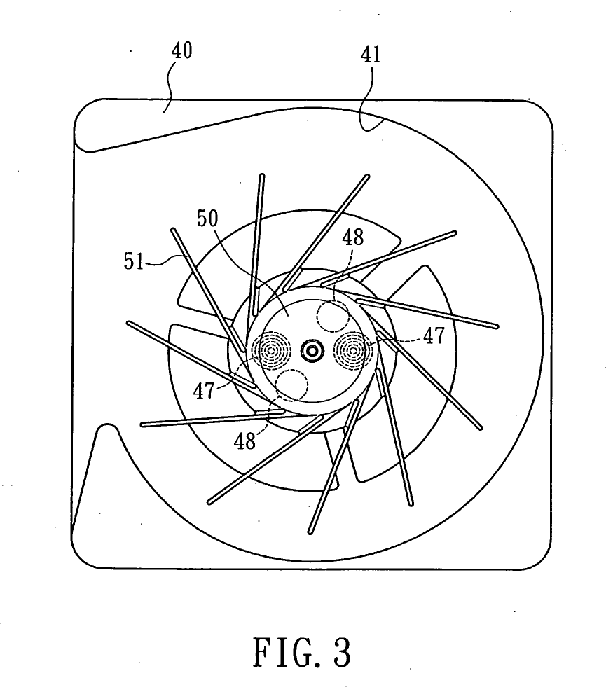

Referring to FIG. 3, at least two positioning members 48 (two in this example) are provided on the base 43 and located outside the axial tube 44. The positioning members 48 are made of magnetically conductive materials (such as iron) and diametrically opposed to each other. The positioning members 48 provide a downward magnetic attraction to the magnet 53 of the impeller rotor 50, maintaining rotational balance of the impeller rotor 50.

The downward magnetic attraction also prevents disengagement of the impeller rotor 50 during rotation. Further, when the impeller rotor 50 is at rest, the positioning members 48 attract the magnet 53 of the impeller rotor 50 to retain the impeller rotor 50 in an angular position most suitable for starting and to prevent the impeller rotor 50 from resting at a dead point for starting, thereby reducing the power required for starting.

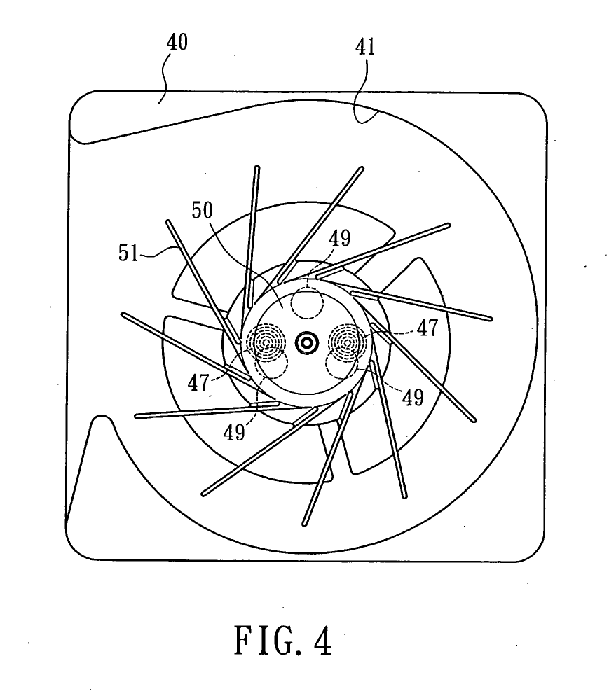

FIG. 4 is a plan view of a second embodiment of the small heat-dissipating device in accordance with the present invention. In this embodiment, three positioning members 49 are mounted on the base 43 and outside the axial tube 44 and spaced at regular angular intervals on the base. The positioning members 49 provide a downward magnetic attraction to the magnet 53 of the impeller rotor 50, maintaining rotational balance of the impeller rotor 50.

As apparent from the foregoing, by provision of the positioning members 48, 49, disengagement of the impeller rotor 50 during rotation is prevented. Further, when the impeller rotor 50 is at rest, the positioning members 48, 49 attract the magnet 53 of the impeller rotor 50 to retain the impeller rotor 50 in an angular position most suitable for starting and to prevent the impeller rotor 50 from resting at a dead point for starting. Further, the number of the positioning members 48, 49 is at least two without adversely affecting strength and stability of the base 43, avoiding deformation or breaking of the axial tube 44.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A small heat-dissipating device comprising:
an impeller rotor comprising a plurality of vanes on an over circumference thereof, a magnet being fixed to a bottom surface of the impeller rotor, a shaft being fixed to a center of the impeller rotor;
a circuit board including at least one coil mounted thereon and in association with the magnet; and
a casing including a compartment delimited by a base, the circuit board being mounted on the base, an axial tube extending from a center of the base, a bearing being mounted in the axial tube for rotatably supporting the shaft of the impeller rotor, at least two positioning members being mounted on the base and outside the axial tube, said at least two positioning members being made of magnetically conductive materials.

2. The small heat-dissipating device as claimed in claim 1 wherein the number of said at least two positioning members is two, the two positioning members being diametrically opposed to each other.

3. The small heat-dissipating device as claimed in claim 1 wherein the number of said at least two positioning members is three, the three positioning members being spaced by regular angular intervals on the base.

4. The small heat-dissipating device as claimed in claim 1 further comprising an air outlet in a side of the compartment, a lid being mounted on top of the casing and including an air inlet facing the impeller rotor.
